(19) United States
(12) Patent Application Publication
(10) Pub. No.: US 2026/0316015 A1
(43) Pub. Date: Oct. 15, 2026

(54) GAS SEPARATION MEMBRANE, GAS SEPARATION MODULE, METHOD FOR PRODUCING GAS SEPARATION MODULE, GAS SEPARATION AND RECOVERY SYSTEM, AND GAS SEPARATION AND RECOVERY METHOD

(71) Applicant: DIC Corporation, Tokyo (JP)

(72) Inventor: Takahiko Otsubo, Sakura-shi (JP)

(73) Assignee: DIC Corporation, Tokyo (JP)

(21) Appl. No.: 19/483,005

(22) PCT Filed: May 10, 2024
(86) PCT No.: PCT/JP2024/017505

§ 371 Date: Nov. 10, 2025

(30) Foreign Application Priority Data
May 31, 2023 (JP) 2023-089979

(51) Int. Cl. B01D 69/08; B01D 53/22; B01D 63/04; B01D 69/10; B01D 69/12

(52) U.S. Cl. CPC B01D 69/08; B01D 53/226; B01D 53/228; B01D 63/046; B01D 69/10; B01D 69/1216; B01D 2053/224

(57) ABSTRACT

A gas separation membrane includes a hollow fiber membrane in a form of a hollow fiber having a lumen inside, and a separation function gel containing a carrier capable of chemically interacting with an acid gas. The hollow fiber membrane has a porous layer adjacent to the lumen and a dense layer located on an outer peripheral side of the porous layer. The separation function gel is supported on a surface of the porous layer. A gas separation module includes a gas separation membrane, a housing that accommodates the gas separation membrane, and a partition that divides a region inside the housing into a lumen-side region communicatively connected to the lumen and a shell-side region not communicatively connected to the lumen. The housing has a lumen-side region port communicatively connected to the lumen-side region and a shell-side region port communicatively connected to the shell-side region.

### TECHNICAL FIELD

The present invention relates to a gas separation membrane, a gas separation module, a method for producing a gas separation module, a gas separation and recovery system, and a gas separation and recovery method.

### BACKGROUND ART

In recent years, there has been a growing demand for technology to separate and recover acid gases such as carbon dioxide. In particular, there is a strong demand for carbon neutrality, which means zero emissions of greenhouse gases as a whole. To achieve carbon neutrality, technology to separate and recover carbon dioxide is required.

PTL 1 describes a gas separation membrane (gaseous substance separation membrane) for separating gas components such as carbon dioxide from a mixed raw material gas. The gas separation membrane includes a substrate membrane with many pores and a separation active layer. The substrate membrane has a porous layer with pores and a dense layer with no pores. The gas separation membrane is provided on the dense layer of the substrate membrane. PTL 1 also describes a gas separation module in which when the substrate layer is made of hollow fibers, both ends of a bundle of hollow fibers accommodated in a housing are secured with adhesive. The gas separation membrane is produced by impregnating the substrate membrane in a viscous aqueous solution, coating a surface of the substrate membrane with a coating solution made of an aqueous solution containing a gas separating polymer that forms the separation active layer, and drying off the solvent in the coating solution from the substrate membrane.

CITATION LIST

### Patent Literature

PTL 1: WO 2018/043053

### SUMMARY OF INVENTION

### Technical Problem

In order to separate acid gases such as carbon dioxide using a hollow fiber membrane, it is effective to improve the permeability and selectivity of acid gases. To improve the permeability and selectivity of acid gases, it is effective to increase the membrane area for the separation active layer. However, in the gas separation membrane described in PTL 1, it is impossible to increase the surface area of the separation active layer beyond the area of the outer surface of the substrate membrane because the separation active layer is provided on the dense layer of the substrate membrane. This limits the improvement of the permeability and selectivity of acid gases.

Moreover, in the production of the gas separation module described in PTL 1, the gas separation membrane needs to be installed into the housing after the gas separation membrane is fabricated by performing steps of impregnating the substrate membrane with a viscous aqueous solution, coating the surface of the substrate membrane with a coating solution, and drying the solvent of the coating solution. This also makes production complicated.

An object of the present invention is to provide a gas separation membrane, a gas separation module, a method for producing a gas separation module, a gas separation and recovery system, and a gas separation and recovery method that can improve the permeability and selectivity of acid gases.

### Solution to Problem

A gas separation membrane of the present invention includes: a hollow fiber membrane in a form of a hollow fiber having a lumen inside; and a separation function gel containing a carrier capable of chemically interacting with an acid gas. The hollow fiber membrane has a porous layer adjacent to the lumen and a dense layer located on an outer peripheral side of the porous layer. The separation function gel is supported on a surface of the porous layer.

In this gas separation membrane, since the separation function gel is supported on the surface of the porous layer, an acid gas can be selectively separated. Moreover, since the porous layer adjacent to the lumen has open pores that are open to the lumen, the surface of the porous layer includes not only the inner peripheral surface of the porous layer but also a pore-forming surface that forms an open pore open to the lumen. Therefore, the surface area of the separation function gel can be increased to more than the area of the inner peripheral surface of the hollow fiber membrane. This configuration can improve the permeability and selectivity of acid gases.

In the gas separation membrane according to [1] above, the separation function gel may be supported on an inner peripheral surface of the porous layer and on a pore-forming surface that forms an open pore open to the lumen.

In this gas separation membrane, since the separation function gel is supported on the inner peripheral surface of the porous layer and on the pore-forming surface that forms an open pore open to the lumen, the permeability and selectivity of acid gases can be improved.

[3] In the gas separation membrane according to [1] or above, the separation function gel may cover the surface of the porous layer. In this gas separation membrane, since the separation function gel covers the surface of the porous layer, the permeability and selectivity of acid gases can be improved.

[4] In the gas separation membrane according to any one of [1] to [3] above, the carrier may be capable of chemically interacting with carbon dioxide. In this gas separation membrane, since the separation function gel contains a carrier capable of chemically interacting with carbon dioxide, carbon dioxide can be selectively separated.

[5] In the gas separation membrane according to [4] above, a separation factor of carbon dioxide relative to nitrogen may be 2 or more and 100,000 or less. In this gas separation membrane, since the separation function gel is supported on the surface of the porous layer, the separation factor of carbon dioxide relative to nitrogen can be increased. Since the separation factor of carbon dioxide relative to nitrogen is 2 or more, the permeation of nitrogen accompanying carbon dioxide can be suppressed. This configuration enhances the performance of carbon dioxide separation. On the other hand, since the separation factor of carbon dioxide relative to nitrogen is 100,000 or less, the gas separation membrane can be readily produced.

[6] In the gas separation membrane according to any one of [1] to [5] above, the carrier may be an ionic liquid. In this gas separation membrane, since the carrier, ionic liquid, is contained in the separation function gel, the carrier can chemically interact with acid gases, especially carbon dioxide, appropriately.

[7] A gas separation module of the present invention includes the gas separation membrane according to any one of to [6] above, a housing that accommodates the gas separation membrane, and a partition that divides a region inside the housing into a lumen-side region communicatively connected to the lumen and a shell-side region not communicatively connected to the lumen. The housing has a lumen-side region port communicatively connected to the lumen-side region and a shell-side region port communicatively connected to the shell-side region.

In this gas separation module, the region inside the housing is divided into the lumen-side region communicatively connected to the lumen and the shell-side region not communicatively connected to the lumen. Therefore, when a target gas including an acid gas is supplied from one of the lumen-side region or the shell-side region, the acid gas can be selectively separated from the target gas and permeate through the gas separation membrane. Since the housing has the lumen-side region port communicatively connected to the lumen-side region and the shell-side region port communicatively connected to the shell-side region, the target gas can be supplied from one of the lumen-side region port or the shell-side region port, and the acid gas can be recovered from the other of the lumen-side region or the shell-side region. Moreover, since the gas separation module includes the gas separation membrane described above, the permeability and selectivity of acid gases can be improved.

[8] In the gas separation module according to [7] above, the lumen-side region port may have a first lumen-side region port and a second lumen-side region port located opposite to each other with respect to the lumen. In this gas separation module, since the lumen-side region port has the first lumen-side region port and the second lumen-side region port located opposite to each other with respect to the lumen, a flow path through the lumen-side region is formed between the first and second lumen-side region ports. This configuration can enhance distribution of a fluid in the lumen-side region.

[9] In the gas separation module according to [7] or [8] above, the shell-side region port may have a first shell-side region port and a second shell-side region port separated from each other. In this gas separation module, since the shell-side region port has the first shell-side region port and the second shell-side region port separated from each other, a flow path through the shell-side region is formed between the first and second shell-side region ports. This configuration can enhance distribution of a fluid in the shell-side region.

[10] A method for producing a gas separation module of the present invention includes: a preparation step of preparing a module intermediate in which the separation function gel is not supported on the surface of the porous layer in the gas separation module according to any one of [7] to [9] above; a supply step of supplying a gel liquid including the carrier to the lumen-side region of the module intermediate; a discharge step of discharging the gel liquid from the lumen-side region; and a gel generation step of gelating the gel liquid remaining in the lumen-side region.

In this method for producing a gas separation module, the gel liquid is supplied to the lumen-side region of the module intermediate, which is the gas separation module having no separation function gel supported on the surface of the porous layer, so that the gel liquid can adhere to the surface of the porous layer. Then, the gel liquid is discharged from the lumen-side region and the gel liquid remaining in the lumen-side region is gelated to generate the separation function gel supported on the surface of the porous layer. With this process, the gas separation module with the separation function gel supported on the surface of the porous layer can be produced. In other words, it is possible to produce the gas separation module that can improve the permeability and selectivity of acid gases. Moreover, the gas separation module can be readily produced because the separation function gel can be supported on the surface of the porous layer after the module intermediate having the hollow fiber membrane accommodated in the housing is fabricated.

[11] A gas separation and recovery system of the present invention includes: the gas separation module according to any one of [7] to [9] above; a target gas supply device communicatively connected to a target gas region to supply a target gas including an acid gas to the target gas region, the target gas region being one of the lumen-side region or the shell-side region of the gas separation module; and an acid gas recovery device communicatively connected to a recovery region to suction the recovery region, the recovery region being the other of the lumen-side region or the shell-side region of the gas separation module.

In this gas separation and recovery system, the target gas is supplied to the target gas region and the recovery region is suctioned so that the acid gas can be selectively separated from the target gas and permeate through the gas separation membrane. With this configuration, the acid gas can be recovered from the recovery region. Moreover, since the gas separation membrane described above is provided, the permeability and selectivity of acid gases can be improved.

[12] A gas separation and recovery system of the present invention includes: a first gas separation module that is the gas separation module according to any one of [7] to [9] above; and a second gas separation module that is the gas separation module according to any one of [7] to [9] above. A target gas region that is one of the lumen-side region or the shell-side region of the second gas separation module is communicatively connected to a recovery region that is the other of the lumen-side region or the shell-side region of the first gas separation module.

In this gas separation and recovery system, the target gas passes through the first and second gas separation and recovery systems, thereby increasing the concentration of the recovered acid gas. Therefore, even when the performance of acid gas separation is not sufficient with one gas separation module, the concentration of recovered acid gas can be sufficiently increased.

[13] The gas separation and recovery system according to [12] above may further include a pump disposed in a flow path communicatively connecting the recovery region of the first gas separation module and the target gas region of the second gas separation module. This gas separation and recovery system includes the pump disposed in a flow path communicatively connecting the recovery region of the first gas separation module and the target gas region of the second gas separation module, so that the gas recovered in the recovery region of the first gas separation module can be pressurized and supplied to the target gas region of the second gas separation module.

[14] The gas separation and recovery system according to [12] or [13] above may further include: a target gas supply device communicatively connected to a target gas region to supply a target gas including an acid gas to the target gas region, the target gas region being one of the lumen-side region or the shell-side region of the first gas separation module; and an acid gas recovery device communicatively connected to a recovery region to suction the recovery region, the recovery region being the other of the lumen-side region or the shell-side region of the second gas separation module. Since this gas separation and recovery system includes the target gas supply device and the acid gas recovery device, the target gas can be supplied to the gas separation and recovery system and the acid gas can be recovered from the gas separation and recovery system without connecting another device.

[15] A gas separation and recovery method of the present invention for separating and recovering an acid gas from a target gas including the acid gas using the gas separation and recovery system according to [11] or [14] above includes: supplying the target gas to the target gas region from the target gas supply device; and suctioning the recovery region to recover the acid gas from the recovery region.

In this gas separation and recovery method, since the target gas is supplied to the target gas region from the target gas supply device and the recovery region is suctioned to recover the acid gas from the recovery region in the gas separation and recovery system described above, the permeability and selectivity of acid gases can be improved, thereby improving the separation and recovery efficiency of acid gases.

### Advantageous Effects of Invention

According to the present invention, the permeability and selectivity of acid gases can be improved.

### BRIEF DESCRIPTION OF DRAWINGS

FIG. 1 is a schematic cross-sectional view of a gas separation module according to an embodiment of the present invention.

FIG. 2 is a schematic cross-sectional view along line II-II in FIG. 1.

FIG. 3 is a schematic cross-sectional view along line III-III in FIG. 2.

FIG. 4 is a schematic cross-sectional view illustrating a preparation step in a method for producing a gas separation module.

FIG. 5 is a schematic cross-sectional view along line V-V in FIG. 4.

FIG. 6 is a schematic cross-sectional view illustrating a supply step in the method for producing a gas separation module.

FIG. 7 is a schematic cross-sectional view along line VII-VII in FIG. 6.

FIG. 8 is a schematic cross-sectional view illustrating a discharge step in the method for producing a gas separation module.

FIG. 9 is a schematic cross-sectional view along line IX-IX in FIG. 8.

FIG. 10 is a schematic diagram of a gas separation and recovery system according to an embodiment of the present invention.

FIG. 11 is an enlarged schematic cross-sectional view of a part of the inside of the gas separation module.

FIG. 12 is a schematic diagram of another gas separation and recovery system according to an embodiment of the present invention.

FIG. 13 is a schematic cross-sectional view of a gas separation module according to a modification.

FIG. 14 is a schematic cross-sectional view of a gas separation module according to another modification.

FIG. 15 is a schematic diagram of a gas separation and recovery system according to a modification.

### DESCRIPTION OF EMBODIMENTS

A gas separation membrane, a gas separation module, a method for producing a gas separation module, a gas separation and recovery system, and a gas separation and recovery method according to embodiments will be described below with reference to the drawings. In the drawings, identical or equivalent parts are denoted by the same symbols, and redundant explanations are omitted.

### Gas Separation Membrane, Gas Separation Module

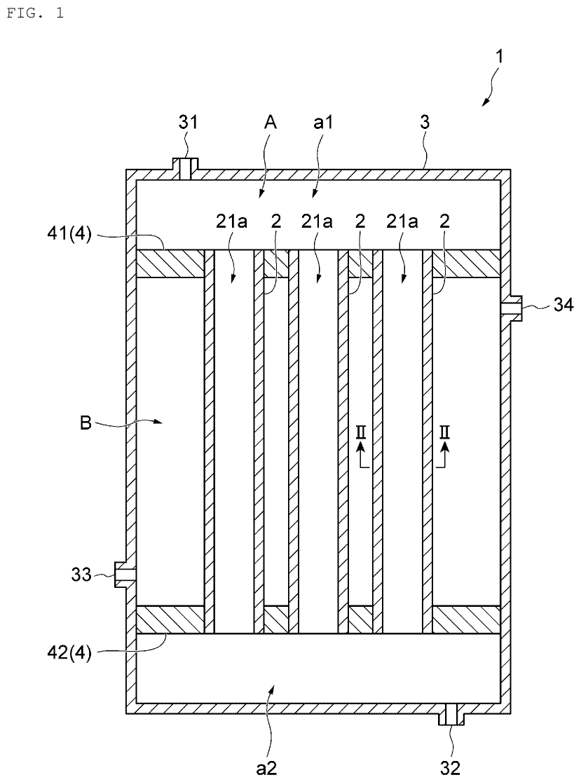

FIG. 1 is a schematic cross-sectional view of a gas separation module according to an embodiment of the present invention. A gas separation module 1 illustrated in FIG. 1 is a module for selectively separating an acid gas from a target gas including the acid gas.

Examples of the acid gas include carbon dioxide (CO₂), nitrogen oxides (NOx) such as nitrogen monoxide and nitrogen dioxide, sulfur oxides (SOx) such as sulfur dioxide and sulfur trioxide, hydrogen sulfide, chlorine, and hydrogen chloride. Among these, the acid gas is preferably carbon dioxide from the viewpoint of achieving carbon neutrality.

Examples of the target gas include exhaust gas from power plants such as thermal power plants and biomass power plants, exhaust gas from cement plants, exhaust gas from steel plants, exhaust gas from factories such as oil refineries and chemical plants, exhaust gas from facilities for hydrogen production and ammonia production, and natural gas.

The gas separation module 1 includes one or more gas separation membranes 2, a housing 3, and a partition 4.

The gas separation membrane 2 is a membrane in the form of a hollow fiber. The gas separation membrane 2 has the function of selectively separating an acid gas from a target gas. “Selectively separating an acid gas” means, for example, that an acid gas permeates preferentially because the acid gas permeates faster than gases other than the acid gas.

The outer diameter of the gas separation membrane 2 is not limited, but can be, for example, 100 μm or more and 3000 μm or less, 100 μm or more and 500 μm or less, or 100 μm or more and 300 μm or less. The inner diameter of the gas separation membrane 2 is not limited, but can be, for example, 10 μm or more and 500 μm or less, 50 μm or more and 300 μm or less, or 80 μm or more and 200 μm or less. The thickness of the gas separation membrane 2 is not limited, but can be, for example, 5 μm or more and 200 μm or less, 10 μm or more and 100 μm or less, or 20 μm or more and 50 μm or less.

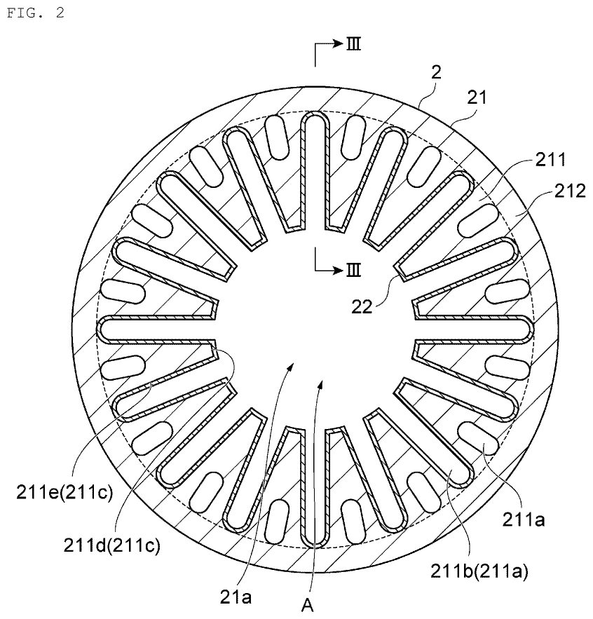

FIG. 2 is a schematic cross-sectional view along line II-II in FIG. 1. As illustrated in FIG. 2, the gas separation membrane 2 includes a hollow fiber membrane 21 and a separation function gel 22.

The hollow fiber membrane 21 is a membrane in the form of a hollow fiber with a lumen 21a inside. The hollow fiber membrane 21 is a permeable membrane that allows a gas such as an acid gas to pass through but does not allow a liquid such as a gel liquid described below to pass through. Examples of the material of the hollow fiber membrane 21 include polyolefin resins such as polypropylene, polyethylene, polymethylpentene (also known as PMP, 4-methylpentene-1, and poly (4-methylpentene-1) ), silicone resins such as polydimethylsiloxane copolymers, and fluorocarbon resins such as PTFE and polyvinylidene fluoride.

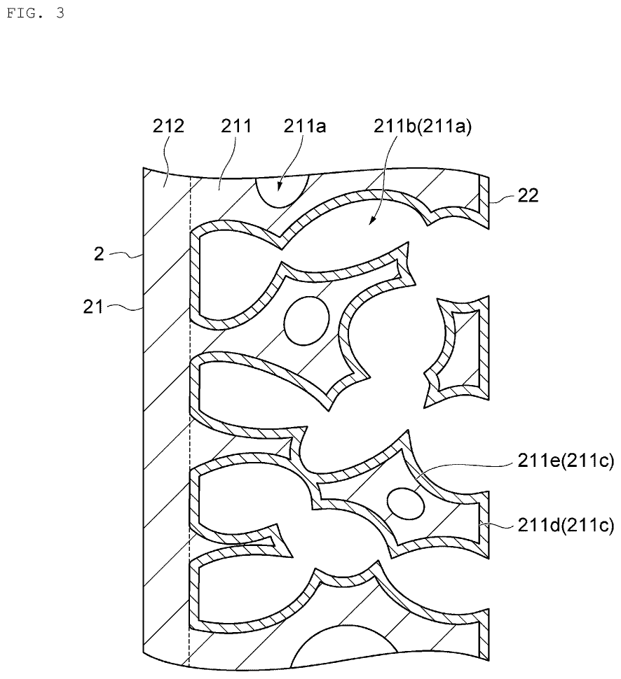

FIG. 3 is a schematic cross-sectional view along line III-III in FIG. 2. As illustrated in FIG. 1 to FIG. 3, the hollow fiber membrane 21 has a porous layer 211 and a dense layer 212.

The porous layer 211 is a layer adjacent to the lumen 21a. In other words, the porous layer 211 is located in the innermost layer of the hollow fiber membrane 21. The porous layer 211 is formed in an annular shape and forms an inner peripheral surface of the hollow fiber membrane 21.

The porous layer 211 has porosity. “Having porosity” means, for example, having a plurality of pores 211a through which the gel liquid can pass. In other words, the porous layer 211 has a plurality of pores 211a through which the gel liquid can pass. The pores 211a include a plurality of open pores 211b open to the lumen 21a. The shape of the open pores 211b is not limited. The open pore 211b may be, for example, a single spherical pore, multiple spherical pores connected together, a single slit-like pore, multiple slit-like pores connected together, or pores having various other shapes. The porous layer 211 is, for example, spongy. The porous layer 211 also functions as a layer that supports the dense layer 212.

The dense layer 212 is a layer located on the outer peripheral side of the porous layer 211 (outer peripheral surface side of the hollow fiber membrane 21). The dense layer 212 is formed in an annular shape and covers the porous layer 211 from the outer peripheral side. The dense layer 212 may be a layer at any position of the hollow fiber membrane 21 as long as it is located on the outer peripheral side of the porous layer 211. From the viewpoint of easily forming the dense layer 212, the dense layer 212 may be located, for example, in the outermost layer of the hollow fiber membrane 21. If the dense layer 212 is not located in the outermost layer of the hollow fiber membrane 21, for example, a layer similar to the porous layer 211 may be formed on the outer peripheral side of the dense layer 212.

The dense layer 212 is a non-porous layer having no porosity. “Having no porosity” means, for example, having no pores through which the gel liquid can pass. In other words, the dense layer 212 has no pores through which the gel liquid can pass. In this case, pores through which the gel liquid is unable to pass may be formed in the dense layer 212.

The separation function gel 22 is a gel containing a carrier capable of chemically interacting with an acid gas. In other words, the separation function gel 22 has the function of selectively separating an acid gas from a target gas by chemically interacting with the acid gas.

Examples of the carrier contained in the separation function gel 22 include an ionic liquid, a deep eutectic solvent (DES), which is a compound that exhibits properties similar to ionic liquids, and an organic amine. The ionic liquid is a salt whose molecules are designed to be liquid at room temperature. The deep eutectic solvent is a compound that is a mixture of a hydrogen bond donor compound and a hydrogen bond acceptor compound and is liquid at room temperature, like ionic liquids.

Examples of the ionic liquid that can suitably chemically interact with carbon dioxide include ionic liquids including cations selected from cations of ammoniums, cations of imidazoliums, and cations of phosphoniums, and anions selected from fluorine-containing anions, cyano group-containing anions, and amino acid-derived anions. Specific examples include ionic liquids that combine cations of ammoniums and fluorine-containing anions (e.g., [N₁₁₁₄] [TFSA], [choline] [TFSA], etc. ) ; ionic liquids that combine cations of imidazoliums and fluorine-containing anions (e.g., [emim] [TFSA], [emim] [TfO], [emim] [BF₄], [bmim] [TFSA], [bmim] [Tf₃C], [bmim] [TfO], [bmim] [BF₄], [bmim] [PF₆], [bmim] [TFA], [hmim] [TFSA], [omim] [TFSA], [C6H₄F₉mim] [TFSA], etc.); ionic liquids that combine cations of imidazoliums and cyano group-containing anions (e.g., [emim] [DCA], [emim] [C (CN)₃], [emim] [B(CN)₄], [bmim] [DCA], [bmim] [C(CN)₃], [bmim] [B(CN)₄], etc.); and ionic liquids that combine cations of phosphoniums and amino acid-derived anions (e.g., [P₄₄₄₄] [Pro], [P₂₂₂₅] [Pro], [P₂₂₂₅] [Gly], etc.). These ionic liquids may be used alone or in combination of two or more.

In the deep eutectic solvent that can suitably chemically interact with carbon dioxide, for example, the hydrogen bond donor can be selected from amide-based, carboxylic acid-based, and alcohol-based compounds, and the hydrogen bond acceptor can be selected from ammonium salts and phosphonium salts. Specific examples include deep eutectic solvents that are mixtures of choline chloride and urea, and mixtures of choline chloride and ethylene glycol.

The separation function gel 22 is supported on a surface 211c of the porous layer 211. As described above, since the dense layer 212 is located on the outer peripheral side of the porous layer 211, there is no surface of the porous layer 211 on the outer peripheral side of the porous layer 211, and the surface of the porous layer 211 is present only on the inner peripheral side (lumen 21a side) of the porous layer 211. Therefore, the surface of the porous layer 211 that leads to the lumen 21a is the surface 211c of the porous layer 211. The surface 211c of the porous layer 211 includes an inner peripheral surface 211d of the porous layer 211 and a pore-forming surface 211e that forms each of the open pores 211b open to the lumen 21a.

The inner peripheral surface 211d is also the inner peripheral surface of the hollow fiber membrane 21. The separation function gel 22 is supported on the inner peripheral surface 211d of the porous layer 211 and on the pore-forming surface 211e that forms each of the open pores 211b open to the lumen 21a.

The separation function gel 22 covers the surface 211c of the porous layer 211. The separation function gel 22 preferably covers the entire surface 211c of the porous layer 211 but does not necessarily cover the entire surface 211c of the porous layer 211. The coverage of the surface 211c of the porous layer 211 by the separation function gel 22 can be, for example, 50% or more, 75% or more, or 90% or more.

One of indicators for separating carbon dioxide from the target gas is a separation factor a of carbon dioxide relative to nitrogen. The separation factor a can be determined, for example, as the ratio of the carbon dioxide permeation rate to the nitrogen permeation rate (carbon dioxide permeation rate/nitrogen permeation rate) after the respective permeation rates of carbon dioxide and nitrogen are determined according to ASTM D-1434. When the separation factor & of carbon dioxide relative to nitrogen of the gas separation membrane 2 is greater than 1, carbon dioxide can be separated from the target gas. The separation function gel 22 supported on the surface 211c of the porous layer 211 increases the separation factor a of carbon dioxide relative to nitrogen of the gas separation membrane 2. From the viewpoint of suppressing the permeation of nitrogen accompanying carbon dioxide, the separation factor a of carbon dioxide relative to nitrogen of the gas separation membrane 2 may be, for example, 2 or more, 10 or more, 30 or more, or 50 or more. The upper limit of the separation factor a of carbon dioxide relative to nitrogen of the gas separation membrane 2 is when only carbon dioxide permeates, in which case the upper limit is infinite. From the viewpoint of easily producing the gas separation membrane 2, the separation factor a of carbon dioxide relative to nitrogen of the gas separation membrane 2 may be, for example, 100,000 or less, 30,000 or less, 5,000 or less, or 1,000 or less. From these viewpoints, the separation factor a of carbon dioxide relative to nitrogen in each of a plurality of gas separation membranes 2 may be, for example, 2 or more and 100, 000 or less, 10 or more and 30,000 or less, 30 or more and 5,000 or less, or 50 or more and 1,000 or less.

As illustrated in FIG. 1, the housing 3 is formed in a cylindrical shape and accommodates a plurality of gas separation membranes 2. The partition 4 divides the region inside the housing 3 into a lumen-side region A communicatively connected to the lumen 21a, and a shell-side region B not communicatively connected to the lumen 21a. In other words, the region inside the housing 3 is divided by the partition 4 into the lumen-side region A and the shell-side region B.

The partition 4 includes, for example, a first sealing section 41 that seals between the ends of one or more gas separation membranes 2 on one side and the housing 3, and a second sealing section 42 that seals between the ends of one or more gas separation membranes 2 on the other side and the housing 3. A plurality of gas separation membranes 2 may be referred to as a membrane bundle.

The first sealing section 41 fills the entire area other than one or more gas separation membranes 2 in a cross-section orthogonal to the central axis of the housing 3. In other words, the first sealing section 41 is filled between the ends of one or more gas separation membranes 2 on one side and the inner wall of the housing 3. When a plurality of gas separation membranes 2 are accommodated in the housing 3, the first sealing section 41 is also filled between the gas separation membranes 2. The lumen 21a of each of one or more gas separation membranes 2 is not sealed by the first sealing section 41, but is open from the first sealing section 41. The first sealing section 41 is formed of, for example, a resin.

The second sealing section 42 fills the entire area other than one or more gas separation membranes 2 in a cross-section orthogonal to the central axis of the housing 3. In other words, the second sealing section 42 is filled between the ends of one or more gas separation membranes 2 on the other side and the inner wall of the housing 3. When a plurality of gas separation membranes 2 are accommodated in the housing 3, the second sealing section 42 is also filled between the gas separation membranes 2. The lumen 21a of each of one or more gas separation membranes 2 is not sealed by the second sealing section 42, but is open from the second sealing section 42. The second sealing section 42 is formed of, for example, a resin.

Therefore, the lumen 21a of each of a plurality of gas separation membranes 2, a region al on the opposite side of the first sealing section 41 from the second sealing section 42, and a region a2 on the opposite side of the second sealing section 42 from the first sealing section 41 are the lumen-side region A. The region outside a plurality of gas separation membranes 2 between the first sealing section 41 and the second sealing section 42 is the shell-side region B.

The housing 3 has first and second lumen-side region ports 31 and 32 communicatively connected to the lumen-side region A, and first and second shell-side region ports 33 and 34 communicatively connected to the shell-side region B.

The first lumen-side region port 31 and the second lumen-side region port 32 are openings that allow the lumen-side region A to be open to the outside of the housing 3. The first lumen-side region port 31 and the second lumen-side region port 32 are located opposite to each other with respect to the lumen 21a. For example, the first lumen-side region port 31 is located on the opposite side of the first sealing section 41 from the second sealing section 42 so as to be adjacent to the region al on the opposite side of the first sealing section 41 from the second sealing section 42 in the lumen-side region A. The second lumen-side region port 32 is located on the opposite side of the second sealing section 42 from the first sealing section 41 so as to be adjacent to the region a2 on the opposite side of the second sealing section 42 from the first sealing section 41 in the lumen-side region A.

The first shell-side region port 33 and the second shell-side region port 34 are openings that allow the shell-side region B to be open to the outside of the housing 3. The first shell-side region port 33 and the second shell-side region port 34 may be in any position, but preferably they are separated from each other and preferably located so as to sandwich one or more gas separation membranes 2 therebetween. For example, the first shell-side region port 33 is located near the second sealing section 42, and the second shell-side region port 34 is located opposite to the first shell-side region port 33 across one or more gas separation membranes 2 near the first sealing section 41.

### Method for Producing Gas Separation Module

A method for producing a gas separation module will now be described. This production method is a method for producing the gas separation module 1 described above.

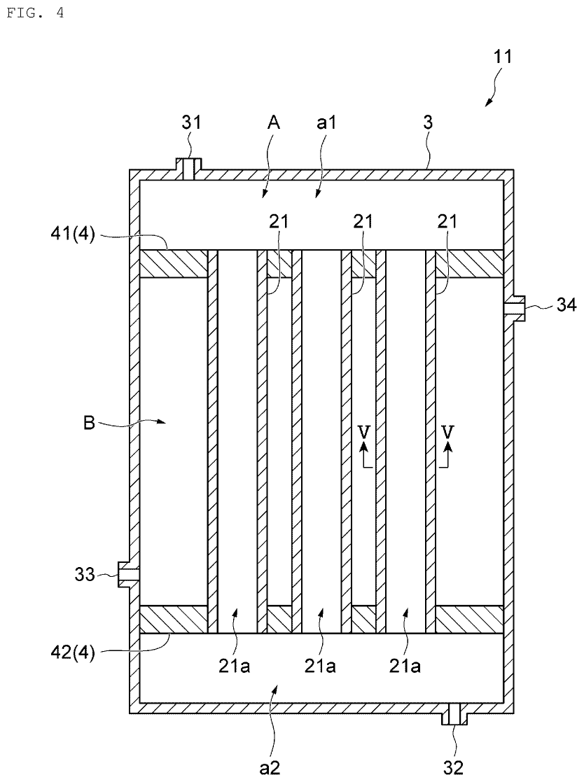

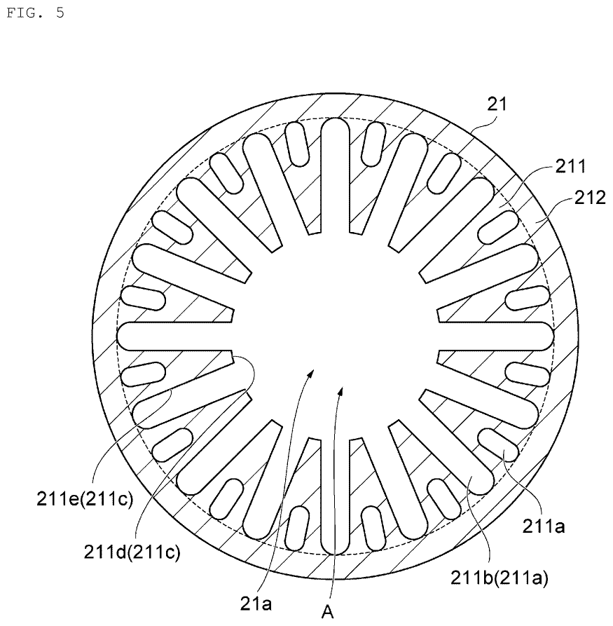

FIG. 4 is a schematic cross-sectional view illustrating a preparation step in a method for producing a gas separation module. FIG. 5 is a schematic cross-sectional view along line V-V in FIG. 4. As illustrated in FIG. 4 and FIG. 5, first, a preparation step is performed to prepare a module intermediate 11. The module intermediate 11 is one in which the separation function gel 22 is not supported on the surface 211c of the porous layer 211 in the gas separation module 1. In other words, the module intermediate 11 is similar to the gas separation module 1 described above, except that the separation function gel 22 is not supported on the surface 211c of the porous layer 211. The module intermediate 11 is therefore a module in which the hollow fiber membrane 21 in the form of a hollow fiber having the lumen 21a inside is accommodated in the housing 3; the hollow fiber membrane 21 has the porous layer 211 adjacent to the lumen 21a and the dense layer 212 located on the outer peripheral side of the porous layer 211; and the region inside the housing 3 is divided by the partition 4 into the lumen-side region A communicatively connected to the lumen 21a and the shell-side region B not communicatively connected to the lumen 21a.

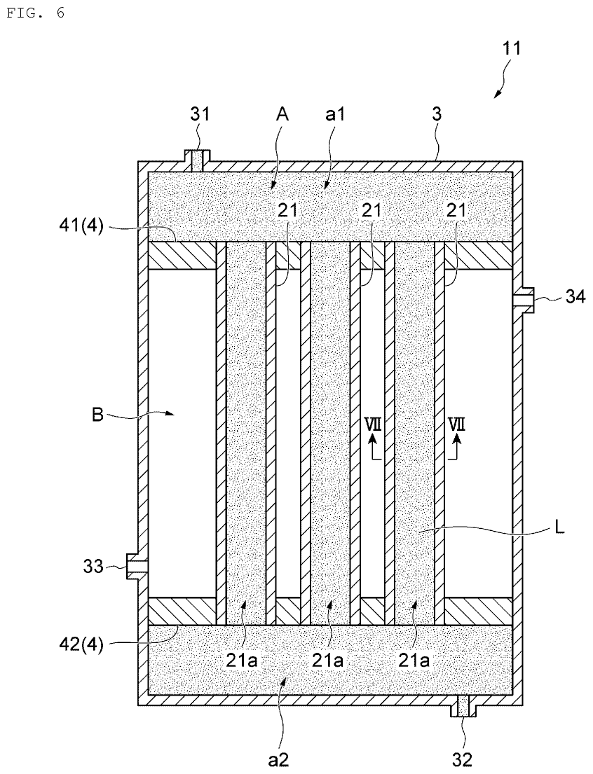

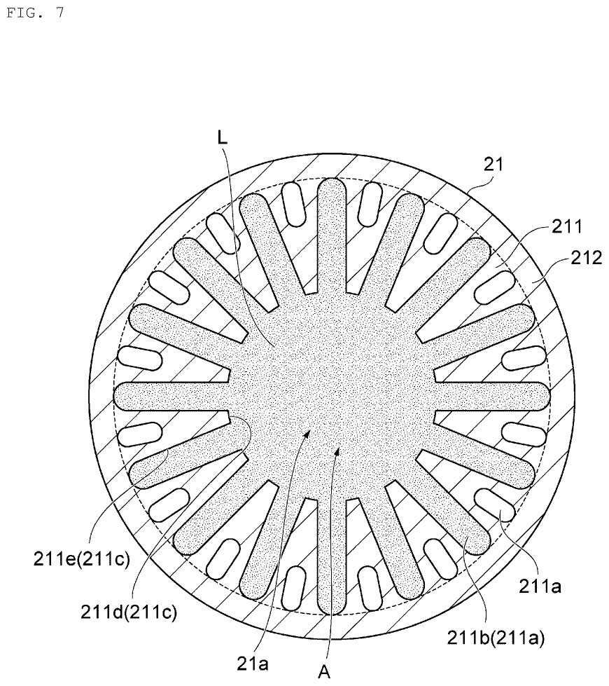

FIG. 6 is a schematic cross-sectional view illustrating a supply step in the method for producing a gas separation module. This schematic cross-sectional view illustrates a supply step in the method for producing a gas separation module. FIG. 7 is a schematic cross-sectional view along line VII-VII in FIG. 6. As illustrated in FIG. 6 and FIG. 7, next, a supply step is performed to supply a gel liquid L containing a carrier capable of chemically interacting with the acid gas to the lumen-side region A of the module intermediate 11. The gel liquid L is a precursor of the separation function gel and is a liquid that becomes the separation function gel by gelation. The gel liquid L is also called sol. The gel liquid L contains, for example, a carrier and a hydrophilic cross-linkable polymer such as polyethylene glycol, polypropylene glycol, polyamine, polyethyleneimine, polyvinyl alcohol, polyacrylic acid, polyacrylamide, gelatin, polyglutamic acid, and polyaspartic acid. Any one of these hydrophilic cross-linkable polymers may be used alone, or two or more may be mixed or copolymerized. In the supply step, for example, the gel liquid L is distributed from the first lumen-side region port 31 to the second lumen-side region port 32 so that the lumen-side region A is filled with the gel liquid L.

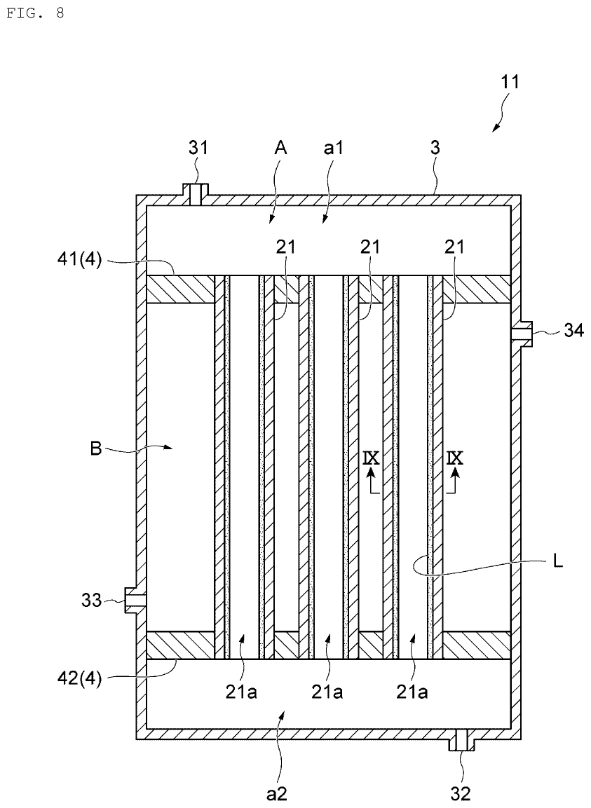

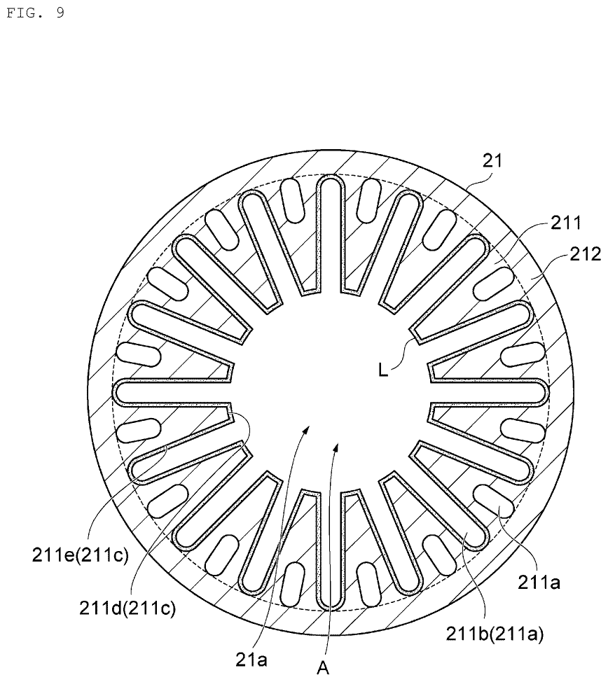

FIG. 8 is a schematic cross-sectional view illustrating a discharge step in the method for producing a gas separation module. FIG. 9 is a schematic cross-sectional view along line IX-IX in FIG. 8. As illustrated in FIG. 8 and FIG. 9, next, a discharge step is performed to discharge the gel liquid L from the lumen-side region A. In the discharge step, the supply of the gel liquid L to the lumen-side region A is stopped, and the gel liquid filled in the lumen-side region A is discharged from the second lumen-side region port 32. At this time, part of the gel liquid L remains in the lumen-side region A and is supported on the surface 211c of the porous layer 211. The gel liquid L may be discharged from the second lumen-side region port 32 by gravity, by extrusion with a pressurizing device (not illustrated), or by suction with a suction device (not illustrated).

Next, a gel generation step is performed to gelate the gel liquid L remaining in the lumen-side region A. Gelation may be performed, for example, by drying the gel liquid L to volatilize a solvent contained in the gel liquid L, or by heating the gel liquid L to accelerate cross-linking of the gel liquid L, or by UV irradiation if cross-linking of the gel liquid L is performed by UV irradiation. Gelation of the gel liquid L produces the separation function gel 22 supported on the surface 211c of the porous layer 211. The gas separation module 1 is thus produced.

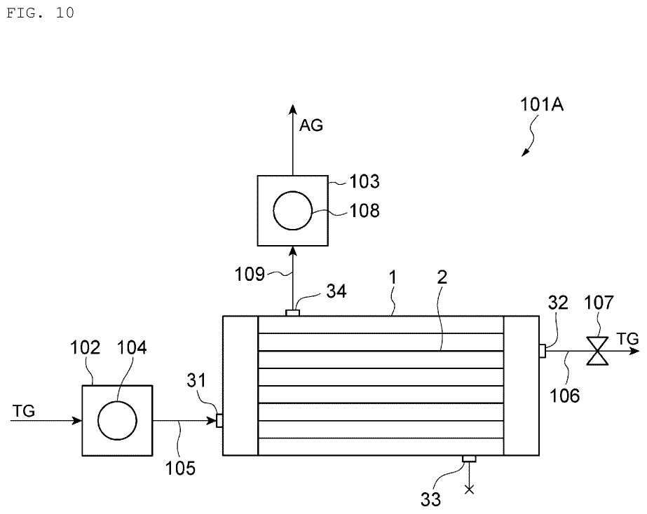

Gas Separation and Recovery System FIG. 10 is a schematic diagram of a gas separation and recovery system according to an embodiment of the present invention. A gas separation and recovery system 101A illustrated in FIG. 10 is a system for selectively separating an acid gas AG from a target gas TG. The gas separation and recovery system 101A includes the gas separation module 1 described above, a target gas supply device 102, and an acid gas recovery device 103.

The target gas supply device 102 is a device communicatively connected to the lumen-side region A of the gas separation module 1 to supply the target gas TG to the lumen-side region A. The target gas supply device 102, for example, has a compressor 104 that compresses and feeds the target gas TG. The compressor 104 operates to compress and supply the target gas TG to the gas separation module 1.

The target gas supply device 102 is connected to the first lumen-side region port 31 of the gas separation module 1 by a target gas supply channel 105. The target gas supply channel 105 is formed of a tubular member such as a pipe. The target gas supply device 102 is connected to the target gas supply channel 105, which is communicatively connected to the lumen-side region A. Therefore, the target gas TG fed from the target gas supply device 102 is supplied to the lumen-side region A of the gas separation module 1 through the target gas supply channel 105. The target gas TG supplied to the lumen-side region A is discharged out of the gas separation and recovery system 101A through the second lumen-side region port 32.

A target gas discharge channel 106 is connected to the second lumen-side region port 32 to discharge the target gas TG from the lumen-side region A. The gas discharged from the target gas discharge channel 106 is ideally a gas from which acid gas has been completely removed from the target gas, but in practice it is the target gas with a reduced concentration of acid gas. For convenience, not only the target gas supplied to the gas separation module 1 but also the target gas with an acid gas concentration reduced by the gas separation module 1 is described herein as the target gas TG. The target gas discharge channel 106 is formed of a tubular member such as a pipe. The target gas discharge channel 106 is provided with a flow control valve 107 that adjusts (limits) the flow rate of the target gas TG so that the target gas TG is maintained in a high pressure state in the lumen-side region A.

The acid gas recovery device 103 is communicatively connected to the shell-side region B of the gas separation module 1 to suction the shell-side region B and recover the acid gas AG from the shell-side region B. The gas recovered by the acid gas recovery device 103 is ideally only acid gas, but in practice it is the target gas with an increased concentration of acid gas. For convenience, not only the acid gas but also the target gas with an acid gas concentration increased by the gas separation module 1 is described herein as the acid gas AG. The acid gas recovery device 103, for example, has a suction device 108, such as a vacuum pump. The suction device 108 operates to suction the shell-side region B and recover the acid gas from the shell-side region B. When the shell-side region B is suctioned, the shell-side region B becomes depressurized, and the acid gas contained in the target gas TG in the lumen-side region A permeates the gas separation membrane 2 and moves to the shell-side region B.

The acid gas recovery device 103 is connected to the second shell-side region port 34 of the gas separation module 1 by an acid gas recovery channel 109. The acid gas recovery channel 109 is formed of a tubular member such as a pipe. The acid gas recovery device 103 is connected to the acid gas recovery channel 109, which is communicatively connected to the shell-side region B. Therefore, the suction force from the suction device 108 acts on the shell-side region B of the gas separation module 1 through the acid gas recovery channel 109. The acid gas that permeates the gas separation membrane 2 is discharged out of the gas separation and recovery system 101A through the acid gas recovery channel 109 and recovered in the acid gas recovery device 103.

The first shell-side region port 33 is closed. However, to facilitate the discharge of acid gas AG from the shell-side region B, a carrier gas supply device (not illustrated) may be connected to the first shell-side region port 33 to supply a carrier gas (sweep gas) such as helium or argon to the shell-side region B.

In the gas separation and recovery system 101A, the lumen-side region A is a target gas region where the target gas TG is supplied, and the shell-side region B is a recovery region where the acid gas AG is recovered by suction.

### Gas Separation and Recovery Method

A gas separation and recovery method will now be described. This gas separation and recovery method is a method for separating and recovering the acid gas AG from the target gas TG using the gas separation and recovery system 101A illustrated in FIG. 10.

As illustrated in FIG. 1 and FIG. 10, first, the target gas TG is supplied to the lumen-side region A from the target gas supply device 102. In other words, the compressor 104 of the target gas supply device 102 is operated to compress and supply the target gas TG to the lumen-side region A through the target gas supply channel 105 and the first lumen-side region port 31. At this time, it is preferable to adjust the flow rate of the target gas TG in the target gas discharge channel 106 with the flow control valve 107 so that the target gas TG is maintained in a high pressure state in the lumen-side region A. The shell-side region B is suctioned by the acid gas recovery device 103. In other words, the suction device 108 is operated to feed gas from the gas separation module 1 side to the opposite side of the gas separation module 1 in the acid gas recovery channel 109 to suction the shell-side region B.

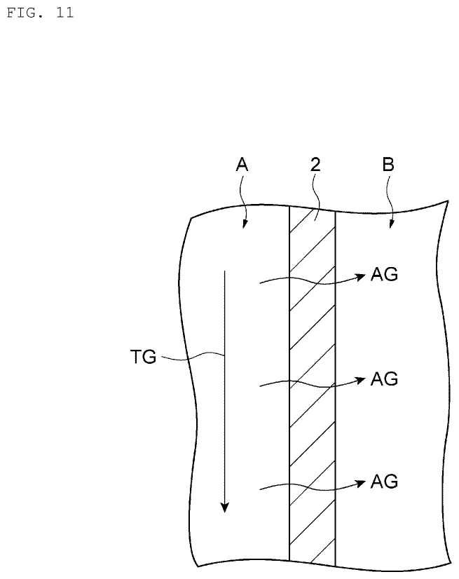

Then, as illustrated in FIG. 11, in the gas separation module 1, the acid gas AG contained in the target gas TG supplied to the lumen-side region A chemically interacts with the separation function gel 22 and permeates the gas separation membrane 2. FIG. 11 is an enlarged schematic cross-sectional view of a part of the inside of the gas separation module. As a result, some or all of the acid gas AG is separated from the target gas TG. The target gas TG from which the acid gas AG has been separated is discharged from the lumen-side region A to the target gas discharge channel 106. On the other hand, the acid gas AG that is separated from the target gas TG and permeates the gas separation membrane 2 is discharged from the shell-side region B to the acid gas recovery channel 109. The acid gas AG is then recovered through the acid gas recovery channel 109.

### Other Gas Separation and Recovery System

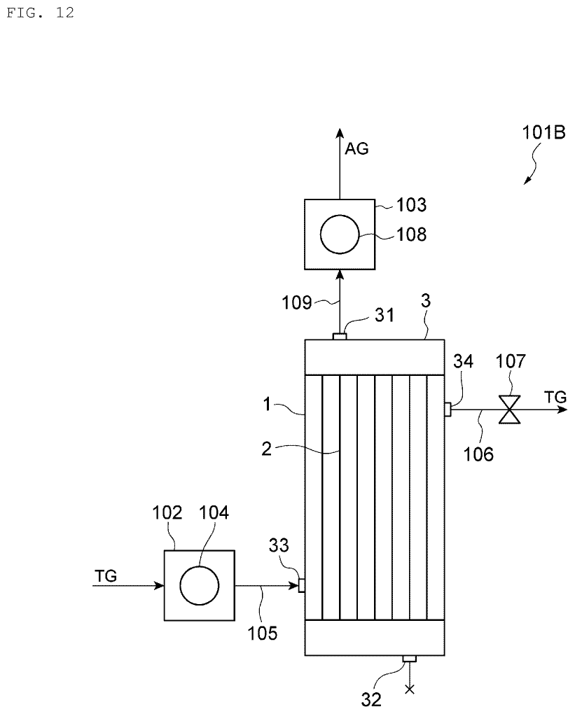

FIG. 12 is a schematic diagram of another gas separation and recovery system according to an embodiment of the present invention. A gas separation and recovery system 101B illustrated in FIG. 11 is basically the same as the gas separation and recovery system 101A illustrated in FIG. 10, but differs from the gas separation and recovery system 101A in that the shell-side region B is the target gas region where the target gas TG is supplied and that the lumen-side region A is the recovery region where the acid gas AG is recovered by suction. Thus, only the points that differ from the gas separation and recovery system 101A are described below, and the same explanations as for the gas separation and recovery system 101A are omitted.

The gas separation and recovery system 101B includes the gas separation module 1 described above, the target gas supply device 102, and the acid gas recovery device 103.

The target gas supply device 102 is connected to the first shell-side region port 33 of the gas separation module 1 by the target gas supply channel 105, which is communicatively connected to the shell-side region B. In other words, the target gas supply device 102 supplies the target gas TG to the shell-side region B.

The target gas discharge channel 106 is connected to the second shell-side region port 34. The target gas discharge channel 106 is provided with the flow control valve 107.

The acid gas recovery device 103 is connected to the first lumen-side region port 31 of the gas separation module 1 by the acid gas recovery channel 109, which is communicatively connected to the lumen-side region A. In other words, the acid gas recovery device 103 suctions the lumen-side region A and recovers the acid gas from the lumen-side region A.

The second lumen-side region port 32 is closed. However, to facilitate the discharge of acid gas AG from the lumen-side region A, a carrier gas supply device (not illustrated) may be connected to the second lumen-side region port 32 to supply a carrier gas to the lumen-side region A.

### Other Gas Separation and Recovery Method

Another gas separation and recovery method will now be described. This gas separation and recovery method is a method for separating and recovering the acid gas AG from the target gas TG using the gas separation and recovery system 101B illustrated in FIG. 12.

As illustrated in FIG. 1 and FIG. 12, first, the target gas TG is supplied to the shell-side region B from the target gas supply device 102. In other words, the compressor 104 of the target gas supply device 102 is operated to compress and supply the target gas TG to the shell-side region B through the target gas supply channel 105 and the first shell-side region port 33. At this time, it is preferable to adjust the flow rate of the target gas TG in the target gas discharge channel 106 with the flow control valve 107 so that the target gas TG is maintained in a high pressure state in the shell-side region B. The lumen-side region A is suctioned by the acid gas recovery device 103. In other words, the suction device 108 is operated to feed gas from the gas separation module 1 side to the opposite side of the gas separation module 1 in the acid gas recovery channel 109 to suction the lumen-side region A.

Then, in the gas separation module 1, the acid gas AG contained in the target gas TG supplied to the shell-side region B chemically interacts with the separation function gel 22 and permeates the gas separation membrane 2. As a result, some or all of the acid gas AG is separated from the target gas TG. The target gas TG from which the acid gas AG has been separated is then discharged from the shell-side region B to the target gas discharge channel 106. On the other hand, the acid gas AG that is separated from the target gas TG and permeates the gas separation membrane 2 is discharged from the lumen-side region A to the acid gas recovery channel 109. The acid gas is then recovered through the acid gas recovery channel 109.

In this way, in the gas separation membrane 2 according to the present embodiment, since the separation function gel 22 is supported on the surface 211c of the porous layer 211, the acid gas AG can be selectively separated. Moreover, since the porous layer 211 adjacent to the lumen 21a has open pores 211b open to the lumen 21a, the surface 211c of the porous layer 211 includes not only the inner peripheral surface 211d of the porous layer 211 but also the pore-forming surface 211e that forms the open pore 211b open to the lumen 21a. Therefore, the surface area of the separation function gel 22 can be increased to more than the area of the inner peripheral surface of the hollow fiber membrane 21. This configuration can improve the permeability and selectivity of acid gas AG.

Further, in this gas separation membrane 2, since the separation function gel 22 is supported on the inner peripheral surface 211d of the porous layer 211 and on the pore-forming surface 211e that forms the open pore 211b open to the lumen 21a, the permeability and selectivity of acid gas AG can be improved.

Further, in this gas separation membrane 2, since the separation function gel 22 covers the surface 211c of the porous layer 211, the permeability and selectivity of acid gas AG can be improved.

Further, in this gas separation membrane 2, since the separation function gel 22 contains a carrier capable of chemically interacting with carbon dioxide, carbon dioxide can be selectively separated.

Further, in this gas separation membrane 2, since the separation function gel 22 is supported on the surface 211c of the porous layer 211, the separation factor a of carbon dioxide relative to nitrogen can be increased. Since the separation factor a of carbon dioxide relative to nitrogen is 2 or more, 10 or more, 30 or more, or 50 or more, the permeation of nitrogen accompanying carbon dioxide can be suppressed. This configuration enhances the performance of carbon dioxide separation. On the other hand, since the separation factor a of carbon dioxide relative to nitrogen is 100,000 or less, 30,000 or less, 5,000 or less, or 1,000 or less, the gas separation membrane 2 can be easily produced.

Further, in this gas separation membrane 2, since the carrier, ionic liquid, is contained in the separation function gel 22, the carrier can chemically interact with acid gases, especially carbon dioxide, appropriately.

In the gas separation module 1 according to the present embodiment, the region inside the housing 3 is divided into the lumen-side region A communicatively connected to the lumen 21a and the shell-side region B not communicatively connected to the lumen 21a. Therefore, when the target gas TG containing the acid gas AG is supplied to one of the lumen-side region A or the shell-side region B, the acid gas AG can be selectively separated from the target gas TG and permeate through the gas separation membrane 2. The housing 3 has the first and second lumen-side region ports 31 and 32 communicatively connected to the lumen-side region A, and the first and second shell-side region ports 33 and 34 communicatively connected to the shell-side region B, so that the target gas TG can be supplied to any of these ports and the acid gas AG can be recovered from any of these ports. Moreover, since the gas separation module 1 includes the gas separation membrane 2 described above, the permeability and selectivity of acid gas AG can be improved.

Further, in this gas separation module 1, the first lumen-side region port 31 and the second lumen-side region port are located opposite to each other with respect to the lumen 21a, so that a flow path through the lumen-side region A is formed between the first lumen-side region port 31 and the second lumen-side region port 32. This configuration can enhance distribution of a fluid in the lumen-side region A.

Further, in this gas separation module 1, the first shell-side region port 33 and the second shell-side region port 34 are separated from each other, so that a flow path through the shell-side region B is formed between the first shell-side region port 33 and the second shell-side region port 34. This configuration can enhance distribution of a fluid in the shell-side region B.

In the method for producing a gas separation module according to the present embodiment, the gel liquid L is supplied to the lumen-side region A of the module intermediate 11, which is the gas separation module 1 having no separation function gel 22 supported on the surface 211c of the porous layer 211, so that the gel liquid L can adhere to the surface 211c of the porous layer 211. Then, the gel liquid L is discharged from the lumen-side region A, and the gel liquid L remaining in the lumen-side region A is gelated to generate the separation function gel 22 supported on the surface 211c of the porous layer 211. The gas separation module 1 with the separation function gel 22 supported on the surface 211c of the porous layer 211 can be produced. In other words, it is possible to produce the gas separation module 1 that can improve the permeability and selectivity of acid gas AG. Moreover, the gas separation module 1 can be readily produced because the separation function gel 22 can be supported on the surface 211c of the porous layer 211 after the module intermediate 11 having the hollow fiber membrane 21 accommodated in the housing 3 is fabricated.

In the gas separation and recovery system 101A according to the present embodiment, the target gas TG is supplied to the lumen-side region A, which is the target gas region, and the shell-side region B, which is the recovery region, is suctioned so that the acid gas AG can be selectively separated from the target gas TG and permeate through the gas separation membrane 2. With this configuration, the acid gas AG can be recovered from the shell-side region B. Moreover, since the gas separation membrane 2 described above is provided, the permeability and selectivity of acid gas AG can be improved.

In another gas separation and recovery system 101B, the target gas TG is supplied to the shell-side region B, which is the target gas region, and the lumen-side region A, which is the recovery region, is suctioned so that the acid gas AG can be selectively separated from the target gas TG and permeate through the gas separation membrane 2. With this configuration, the acid gas AG can be recovered from the lumen-side region A. Moreover, since the gas separation membrane 2 described above is provided, the permeability and selectivity of acid gas AG can be improved.

In the gas separation and recovery method according to the present embodiment, in the gas separation and recovery system 101A or the gas separation and recovery system 101B described above, the target gas TG is supplied from the target gas supply device 102 to the target gas region, which is one of the lumen-side region A or the shell-side region B, and the recovery region, which is the other of the lumen-side region A or the shell-side region B, is suctioned to recover the acid gas AG from the recovery region, so that the permeability and selectivity of acid gas AG can be improved, thereby improving the separation and recovery efficiency of acid gas AG.

Although preferred embodiments of the present invention have been described above, the present invention is not limited to the above embodiments.

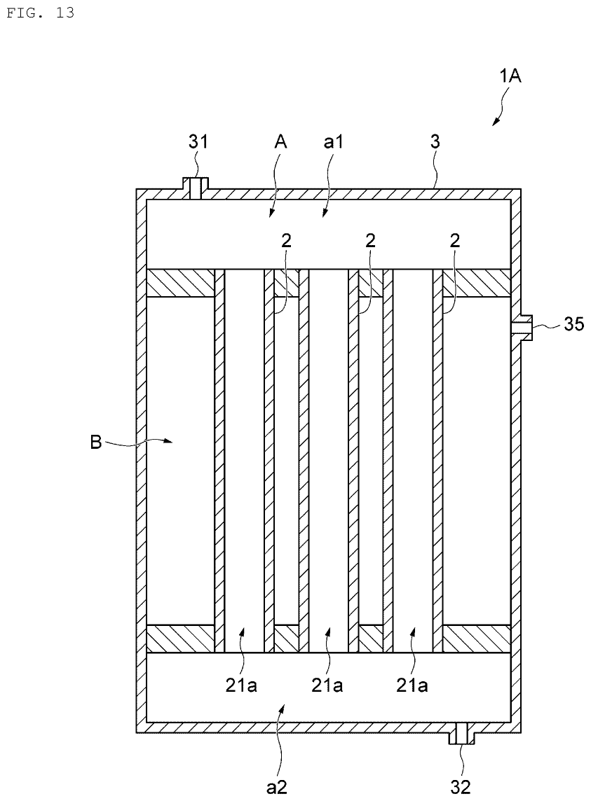

For example, in the gas separation and recovery system 101A described above, one of the two ports communicatively connected to the shell-side region of the gas separation module 1 is closed and not functioning. Thus, for example, only one port may be communicatively connected to the shell-side region B, as in a gas separation module 1A illustrated in FIG. 13. In the gas separation module 1A illustrated in FIG. 13, only one shell-side region port 35 is formed in the housing 3 as a port communicatively connected to the shell-side region B.

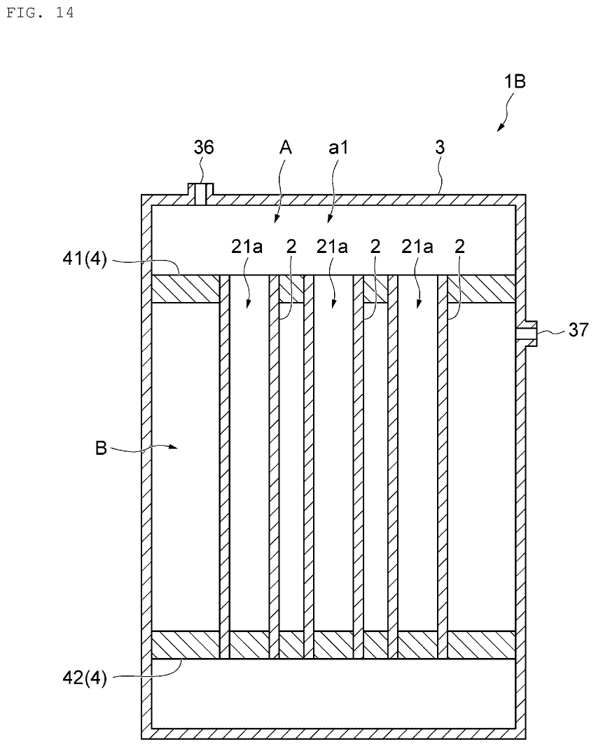

In the above gas separation module 1, the housing is described as having two lumen-side region ports communicatively connected to the lumen-side region and two shell-side region ports communicatively connected to the shell-side region. However, as long as it is possible to supply the target gas and recover the acid gas, and to supply and discharge the gel liquid, only one lumen-side region port may be communicatively connected to the lumen-side region, and only one shell-side region port may be communicatively connected to the shell-side region, as in a gas separation module 1B illustrated in FIG. 14. In the gas separation module 1B illustrated in FIG. 14, only one lumen-side region port 36 is formed in the housing 3 as a port communicatively connected to the lumen-side region A, and only one shell-side region port 37 is formed as a port communicatively connected to the shell-side region B. In this case, the second sealing section 42 may also be filled in the lumen 21a of each of one or more gas separation membranes 2. From the viewpoint of suitable adhesion of the gel liquid to the surface of the porous layer in the production of the gas separation module, it is preferable to have two lumen-side region ports located opposite to each other with respect to the lumen 21a of the gas separation membrane 2 as the lumen-side region ports communicatively connected to the lumen-side region, as in the gas separation module 1A illustrated in FIG. 13.

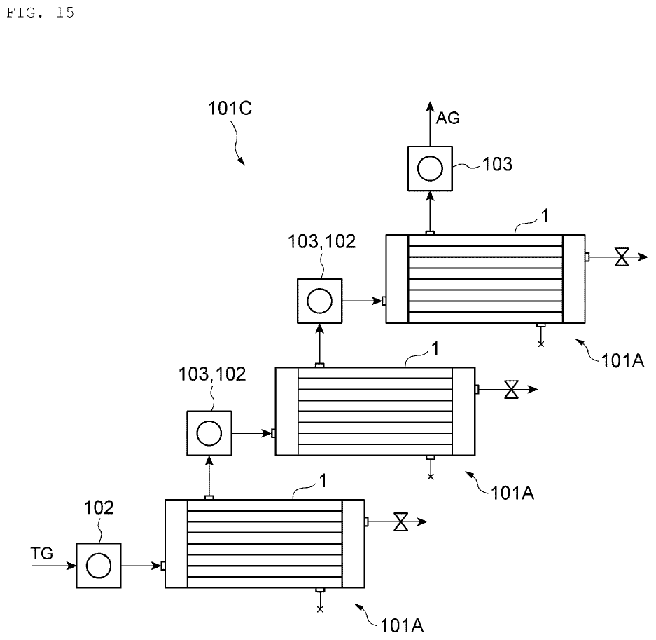

The gas separation and recovery system 101A and the gas separation and recovery system 101B are described as a system using a single gas separation module 1. However, the gas separation and recovery system may be a system of a plurality of gas separation modules connected in series, as in a gas separation and recovery system 101C illustrated in FIG. 15. FIG. 15 is a schematic diagram of a gas separation and recovery system according to a modification. The gas separation and recovery system 101C illustrated in FIG. 15 includes a plurality of gas separation and recovery systems 101A illustrated in FIG. 10, in which a plurality of gas separation modules 1 are connected in series. “A plurality of gas separation modules 1 are connected in series” means that a plurality of gas separation modules 1 are connected so that the target gas TG flows through a plurality of gas separation modules 1 in series. In the gas separation and recovery system 101C illustrated in FIG. 15, the acid gas recovery device 103 of the gas separation and recovery system 101A on a first stage is also used as the target gas supply device 102 of the gas separation and recovery system 101A on a second stage, and the acid gas recovery device 103 of the gas separation and recovery system 101A on the second stage is also used as the target gas supply device 102 of the gas separation and recovery system 101A on a third stage. When the acid gas recovery device 103 of the gas separation and recovery system 101A on the preceding stage (upstream) is also used as the target gas supply device 102 of the gas separation and recovery system 101A on the following stage (downstream), they may be configured with a single pump. In other words, a pump may be disposed in a flow path that communicatively connects the recovery region (the other of the lumen-side region A or the shell-side region B) of the gas separation module 1 (first gas separation module) on the preceding stage (upstream) to the target gas region (one of the lumen-side region A or the shell-side region B) of the gas separation module 1 (second gas separation module) on the following stage (downstream). The pump is a device that pressurizes and feeds the supplied gas, and can be similar to the compressor 104 or the suction device 108, for example.

In the gas separation and recovery system 101C configured in this way, the concentration of the recovered acid gas AG is increased each time the target gas TG passes through the gas separation and recovery system 101A on each stage. Therefore, even when the performance of separation of acid gas AG is not sufficient with a single gas separation module 1, the concentration of the recovered acid gas AG can be sufficiently increased.

In FIG. 15, three gas separation and recovery systems 101A are connected as an example. However, two gas separation and recovery systems 101A may be connected, or four or more gas separation and recovery systems 101A may be connected. In FIG. 15, as an example, a plurality of gas separation and recovery systems 101A are connected. However, a plurality of gas separation and recovery systems 101B may be connected, or a plurality of other gas separation and recovery systems (not illustrated) may be connected, or a plurality of gas separation and recovery systems different from each other (not illustrated) may be connected.

### Reference Signs List

1 gas separation module
1A gas separation module
1B gas separation module
2 gas separation membrane
3 housing
4 partition
11 module intermediate
21 hollow fiber membrane
21a lumen
211 porous layer
211a pore
211b open pore
211c surface
211d inner peripheral surface
211e pore-forming surface
212 dense layer
22 separation function gel
31 first lumen-side region port
32 second lumen-side region port
33 first shell-side region port
34 second shell-side region port
35 shell-side region port
36 lumen-side region port
37 shell-side region port
41 first sealing section
42 second sealing section
101A gas separation and recovery system
101B gas separation and recovery system
102 target gas supply device
103 acid gas recovery device
104 compressor
105 target gas supply channel
106 target gas discharge channel
107 flow control valve
108 suction device
109 acid gas recovery channel
A lumen-side region (target gas region, recovery region)
a1 region
a2 region
B shell-side region (recovery region, target gas region)
TG target gas
AG acid gas
L gel liquid

1. A gas separation membrane comprising:
a hollow fiber membrane in a form of a hollow fiber having a lumen inside; and
a separation function gel including a carrier capable of chemically interacting with an acid gas, wherein
the hollow fiber membrane has
a porous layer adjacent to the lumen and
a dense layer located on an outer peripheral side of the porous layer, and the separation function gel is supported on a surface of the porous layer.

2. The gas separation membrane according to claim 1, wherein the separation function gel is supported on an inner peripheral surface of the porous layer and on a pore-forming surface that forms an open pore open to the lumen.

3. The gas separation membrane according to claim 1, wherein the separation function gel covers the surface of the porous layer.

4. The gas separation membrane according to claim 1, wherein the carrier is capable of chemically interacting with carbon dioxide.

5. The gas separation membrane according to claim 4, wherein a separation factor of carbon dioxide relative to nitrogen is 2 or more and 100,000 or less.

6. The gas separation membrane according to claim 1, wherein the carrier is an ionic liquid.

7. A gas separation module comprising:
the gas separation membrane according to claim 1; a housing that accommodates the gas separation membrane; and
a partition that divides a region inside the housing into a lumen-side region communicatively connected to the lumen and a shell-side region not communicatively connected to the lumen, wherein
the housing has
a lumen-side region port communicatively connected to the lumen-side region and
a shell-side region port communicatively connected to the shell-side region.

8. The gas separation module according to claim 7, wherein the lumen-side region port comprises a first lumen-side region port and a second lumen-side region port located opposite to each other with respect to the lumen.

9. The gas separation module according to claim 7, wherein the shell-side region port comprises a first shell-side region port and a second shell-side region port separated from each other.

10. method for producing a gas separation module, the method comprising:
a preparation step of preparing a module intermediate in which the separation function gel is not supported on the surface of the porous layer in the gas separation module according to claim 7;
a supply step of supplying a gel liquid including the carrier to the lumen-side region of the module intermediate;
a discharge step of discharging the gel liquid from the lumen-side region; and
a gel generation step of gelating the gel liquid remaining in the lumen-side region.

11. A gas separation and recovery system comprising:
the gas separation module according to claim 7;
a target gas supply device communicatively connected to a target gas region to supply a target gas including an acid gas to the target gas region, the target gas region being one of the lumen-side region or the shell-side region of the gas separation module; and
an acid gas recovery device communicatively connected to a recovery region to suction the recovery region, the recovery region being the other of the lumen-side region or the shell-side region of the gas separation module.

12. A gas separation and recovery system comprising:
a first gas separation module that is the gas separation module according to any one of claims 7 to 9; and
a second gas separation module that is the gas separation module according to claim 7, wherein
a target gas region that is one of the lumen-side region or the shell-side region of the second gas separation module is communicatively connected to a recovery region that is the other of the lumen-side region or the shell-side region of the first gas separation module.

13. The gas separation and recovery system according to claim 12, further comprising a pump disposed in a flow path communicatively connecting the recovery region of the first gas separation module and the target gas region of the second gas separation module.

14. The gas separation and recovery system according to claim 12, further comprising:
a target gas supply device communicatively connected to a target gas region to supply a target gas including an acid gas to the target gas region, the target gas region being one of the lumen-side region or the shell-side region of the first gas separation module; and
an acid gas recovery device communicatively connected to a recovery region to suction the recovery region, the recovery region being the other of the lumen-side region or the shell-side region of the second gas separation module.

15. A gas separation and recovery method for separating and recovering an acid gas from a target gas including the acid gas, using the gas separation and recovery system according to claim 11, the gas separation and recovery method comprising:
supplying the target gas to the target gas region from the target gas supply device; and
suctioning the recovery region to recover the acid gas from the recovery region.

16. The gas separation membrane according to claim 2, wherein the separation function gel covers the surface of the porous layer.

17. The gas separation membrane according to claim 2, wherein the carrier is capable of chemically interacting with carbon dioxide.

18. The gas separation membrane according to claim 2, wherein the carrier is an ionic liquid.

19. A gas separation module comprising:
the gas separation membrane according to claim 2;
a housing that accommodates the gas separation membrane; and
a partition that divides a region inside the housing into a lumen-side region communicatively connected to the lumen and a shell-side region not communicatively connected to the lumen, wherein
the housing has
a lumen-side region port communicatively connected to the lumen-side region and
a shell-side region port communicatively connected to the shell-side region.

20. The gas separation module according to claim 8, wherein the shell-side region port comprises a first shell-side region port and a second shell-side region port separated from each other.
